(19) United States
(12) Patent Application Publication
(10) Pub. No.: US 2013/0323349 A1
(43) Pub. Date: Dec. 5, 2013

(54) Mold-Tool System Including Actuation Configured to Move Plate Assemblies Attached with Valve-Stem Assemblies of Runners

(71) Applicant: James Osborne Plumpton, Enosburg Falls, VT (US)

(72) Inventor: James Osborne Plumpton, Enosburg Falls, VT (US)

(73) Assignee: HUSKY INJECTION MOLDING SYSTEMS LTD., Bolton, ON (CA)

(21) Appl. No.: 13/981,341

(22) PCT Filed: Jan. 11, 2012
(86) PCT No.: PCT/US12/20864

§ 371 Date: Jul. 24, 2013

Related U.S. Application Data
(60) Provisional application No. 61/437,731, filed on Jan. 31, 2011.

(51) Int. Cl. B29C 45/23

(52) U.S. Cl. CPC B29C 45/23
USPC 425/572

(57) ABSTRACT

A mold-tool system (100), comprising: a first movable-plate assembly (102) being configured to attach with a first valve-stem assembly (202) of a first runner assembly (200); a second movable-plate assembly (104) being configured to attach with a second valve-stem assembly (204) of a second runner assembly (201); and a plate-actuator assembly (106) being coupled with the first movable-plate assembly (102) and with the second movable-plate assembly (104), the plate-actuator assembly (106) being configured to move the first movable-plate assembly (102) and the second movable-plate assembly (104) in opposite directions between a valve-open position and a valve-closed position.

### TECHNICAL FIELD

An aspect generally relates to (but is not limited to) a mold-tool system including (but not limited to) a plate-actuator assembly coupled with a first movable-plate assembly and with a second movable-plate assembly, the plate-actuator assembly configured to move the first movable-plate assembly and the second movable-plate assembly in opposite directions between a valve-open position and a valve-closed position.

### BACKGROUND

U.S. Pat. No. 7,086,852 discloses a stack injection molding apparatus has first and second arrays of valve gate injection nozzles and separate mechanisms for independently actuating the nozzles of each array. A separate reciprocating yoke plate engages the valve pins of each nozzle array, and is actuated by either one centrally located actuator or a pair of symmetrically located actuators.

### SUMMARY

The inventors have researched a problem associated with known molding systems that inadvertently manufacture bad-quality molded articles or parts. After much study, the inventors believe they have arrived at an understanding of the problem and its solution, which are stated below, and the inventors believe this understanding is not known to the public.

More and more, users of molding systems doing precision molding are calling for synchronous valve pin actuation for valve-gated hot runners. The valve pins move together as they are attached to a single plate that moves back and forth. Plate-actuated systems typically use hydraulics, pneumatics or electric motors to move the plate. As these systems become more accepted in the molding industry, molders are likely to move on to stack hot runners with plate actuated valve pins to increase molding-machine output. Using known plate actuation techniques, a stack hot runner with plate actuated valve pins may have an extremely large shut-height (which is a disadvantage).

According to one aspect, there is provided a mold-tool system (100), comprising: a first movable-plate assembly (102) being configured to attach with a first valve-stem assembly (202) of a first runner assembly (200); a second movable-plate assembly (104) being configured to attach with a second valve-stem assembly (204) of a second runner assembly (201); and a plate-actuator assembly (106) being coupled with the first movable-plate assembly (102) and with the second movable-plate assembly (104), the plate-actuator assembly (106) being configured to move the first movable-plate assembly (102) and the second movable-plate assembly (104) in opposite directions between a valve-open position and a valve-closed position.

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

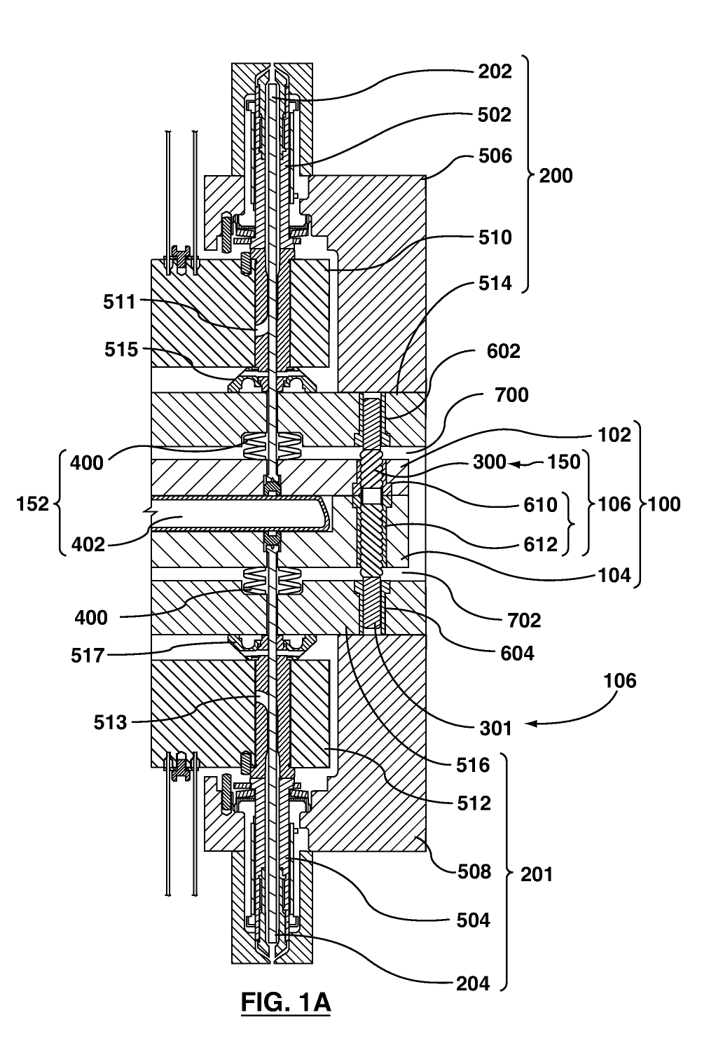

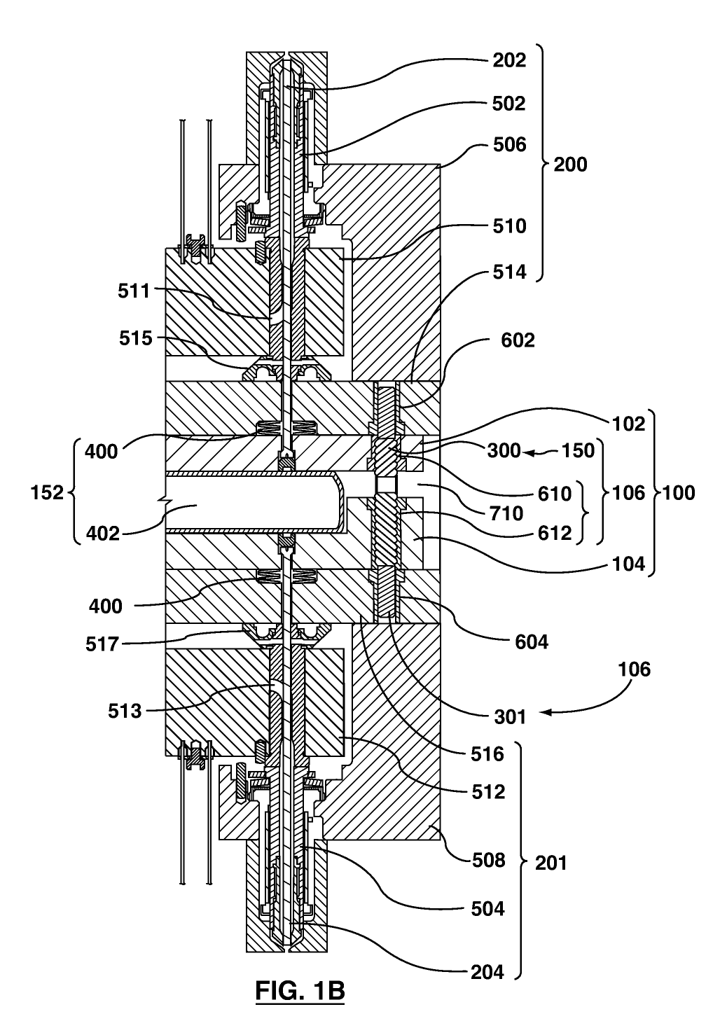

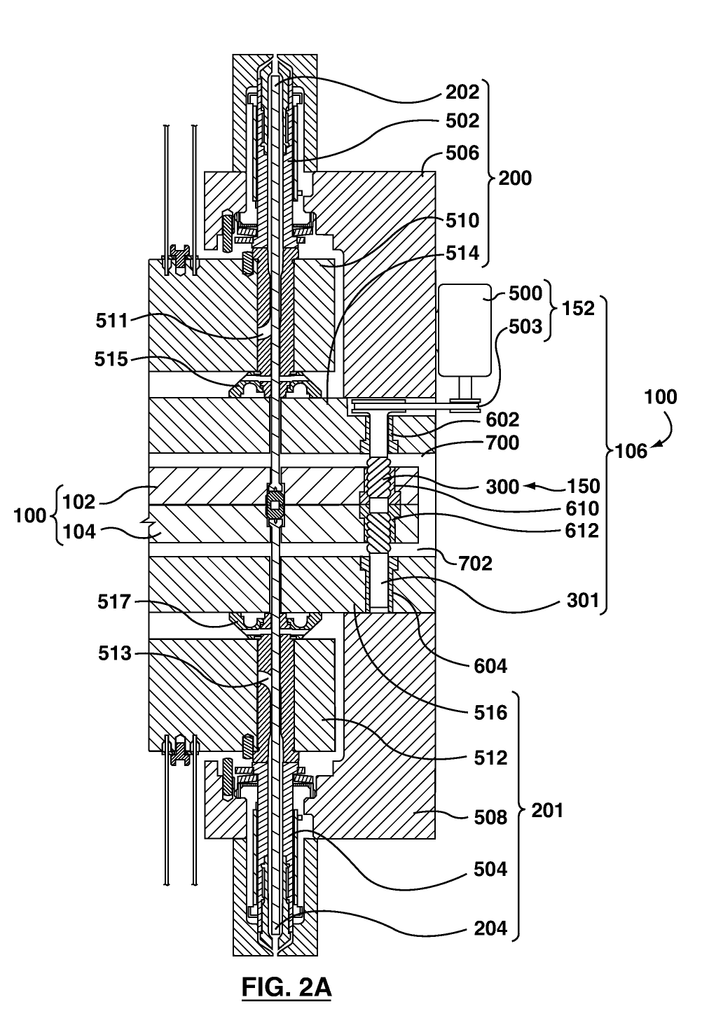

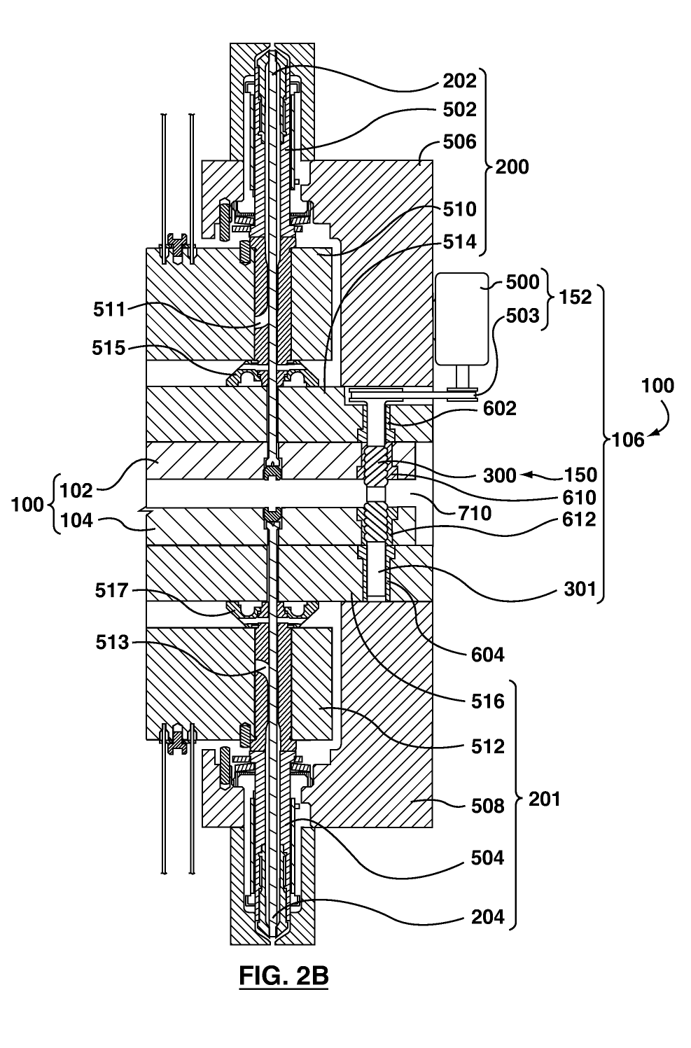

FIGS. 1A, 1B, 2A, 2B depict schematic representations of a mold-tool system (100).

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENT(S)

FIGS. 1A, 1B, 2A, 2B depict the schematic representations (specifically, cross sectional views) of the examples of the mold-tool system (100). The mold-tool system (100) may include components that are known to persons skilled in the art, and these known components will not be described here; these known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9). It will be appreciated that for the purposes of this document, the phrase “includes (but is not limited to)” is equivalent to the word “comprising”. The word “comprising” is a transitional phrase or word that links the preamble of a patent claim to the specific elements set forth in the claim which define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim.

The definition of the mold-tool system (100) is as follows: a system that may be positioned and/or may be used in an envelope defined by a platen system of the molding system, such as an injection-molding system for example. The platen system may include a stationary platen and a movable platen that is moveable relative to the stationary platen. Examples of the mold-tool system (100) may include (and is not limited to): a runner system, such as a hot runner system or a cold runner system, a runner nozzle, a manifold system, and/or any sub-assembly or part thereof, etc.

Referring now to FIGS. 1A, 1B, 2A, 2B, the mold-tool system (100) may include and is not limited to: (i) a first movable-plate assembly (102), (ii) a second movable-plate assembly (104), and (iii) a plate-actuator assembly (106). The first movable-plate assembly (102) may be configured to attach with a first valve-stem assembly (202) of a first runner assembly (200). FIGS. 1A and 2A depict the first valve-stem assembly (202) positioned in a valve-open position, in which melt or a flowable resin may flow from a first nozzle assembly (502). FIGS. 1B and 2B depict the first valve-stem assembly (202) positioned in a valve-closed position, in which melt or a flowable resin may not flow from the first nozzle assembly (502). The second movable-plate assembly (104) may be configured to attach with a second valve-stem assembly (204) of a second runner assembly (201). FIGS. 1A and 2A depict the second valve-stem assembly (204) positioned in the valve-open position, in which melt or a flowable resin may flow from a second nozzle assembly (504). FIGS. 1B and 2B depict the second valve-stem assembly (204) positioned in a valve-closed position, in which melt or a flowable resin may not flow from the second nozzle assembly (504). The plate-actuator assembly (106) may be coupled with the first movable-plate assembly (102) and with the second movable-plate assembly (104). The plate-actuator assembly (106) may be configured to move the first movable-plate assembly (102) and the second movable-plate assembly (104) in opposite directions between the valve-open position (as depicted in FIGS. 1A and 2A) and the valve-closed position (as depicted in FIGS. 1B and 2B). The valve-open position may be defined as contact between the first movable-plate assembly (102) and the second movable-plate assembly (104). The valve-closed position may be defined as non-contact between the first movable-plate assembly (102) and the second movable-plate assembly (104).

By way of example, the first runner assembly (200) may include (and is not limited to) a first nozzle assembly (502) that is connected with a first manifold-plate assembly (506). The first manifold-plate assembly (506) may include a first manifold assembly (510) that defines a first melt channel (511) that is used for distributing a resin (melt) to the first nozzle assembly (502). The first nozzle assembly (502) then conveys the resin to a mold assembly (known and not depicted). The first manifold-plate assembly (506) may also include a first backing plate (514), which may be used with the first manifold-plate assembly (506) to house and support the first manifold assembly (510). A first insulator (515) may be positioned between the first backing plate (514) and the first manifold assembly (510).

By way of example, the second runner assembly (201) may include (and is not limited to) a second nozzle assembly (504) that is connected with a second manifold-plate assembly (508). The second manifold-plate assembly (508) may include a second manifold assembly (512) that defines a second melt channel (513) that is used for distributing the resin to the second nozzle assembly (504). The second nozzle assembly (504) then conveys the resin to another mold assembly (known and not depicted). The second manifold-plate assembly (508) may also include a second backing plate (516), which may be used with the second manifold-plate assembly (508) to house and support the second manifold assembly (512). A second insulator (517) may be positioned between the second backing plate (516) and the second manifold assembly (512).

Referring now to FIGS. 1A, 1B, 2A, 2B, the mold-tool system (100) may be arranged such that the plate-actuator assembly (106) may include (by way of example) and is not limited to: a gear assembly (150). The gear assembly (150) may be coupled to the first movable-plate assembly (102) and the second movable-plate assembly (104). The gear assembly (150) may be configured to align the first movable-plate assembly (102) with the second movable-plate assembly (104) so that a side-to-side movement is maintained between the first movable-plate assembly (102) and the second movable-plate assembly (104). In addition, the gear assembly (150) may be configured to permit simultaneous movement of the first movable-plate assembly (102) with the second movable-plate assembly (104) at a matched speed.

Referring now to FIGS. 1A, 1B, 2A, 2B, the mold-tool system (100) may be arranged such that the plate-actuator assembly (106) may include (by way of example) and is not limited to: a gear-drive assembly (152). The gear-drive assembly (152) may be operatively connected with the gear assembly (150). The gear-drive assembly (152) may be configured to move the gear assembly (150) so that the first movable-plate assembly (102) and the second movable-plate assembly (104) are movable between the valve-open position and the valve-closed position.

By way of example, the gear assembly (150) may include (and is not limited to) a bi-directional ball screw assembly (300) connecting the first movable-plate assembly (102) with the second movable-plate assembly (104). The bi-directional ball screw assembly (300) may be configured such that along a first direction of rotation of the bi-directional ball screw assembly (300), the first movable-plate assembly (102) and the second movable-plate assembly (104) may move closer together; along a second direction of rotation of the bi-directional ball screw assembly (300), the first movable-plate assembly (102) and the second movable-plate assembly (104) may move further apart from each other. The bi-directional ball screw assembly (300) may be attached to each of the first movable-plate assembly (102) and the second movable-plate assembly (104). By way of another example, the gear assembly (150) may include (and is not limited to) the gear assembly (150) may include (and is not limited to) a rack-and-pinion-gear assembly (not depicted but known) connecting the first movable-plate assembly (102) with the second movable-plate assembly (104).

By way of further example, the first movable-plate assembly (102) may define a first shaft channel (602) that may be configured to receive the bi-directional ball screw assembly (300). The first shaft channel (602) may define a first threaded channel (610) that may interact with the bi-directional ball screw assembly (300). In addition, the second movable-plate assembly (104) may define a second shaft channel (604) that may be configured to receive the bi-directional ball screw assembly (300). The second shaft channel (604) may define a second threaded channel (612) that may be configured to interact with the bi-directional ball screw assembly (300). The plate-actuator assembly (106) may include a rotatable shaft (301) of the bi-directional ball screw assembly (300), and the rotatable shaft (301) may be received in the first shaft channel (602) and the second shaft channel (604).

For FIGS. 1A, 2A, for the case were the first valve-stem assembly (202) is positioned in the valve-open position, an open space (700) exists between the first movable-plate assembly (102) and the first backing plate (514) of the first runner assembly (200), and as well, an open space (702) exists between the second movable-plate assembly (104) and the second backing plate (516) of the second runner assembly (201). For FIGS. 1B, 2B, for the case were the first valve-stem assembly (202) is positioned in the valve-closed position, an open space (710) exists between the first movable-plate assembly (102) and the second movable-plate assembly (104).

Referring now to FIGS. 1A, 1B, the mold-tool system (100) may be further adapted so that the gear-drive assembly (152) may include (by way of example and not limited to) a spring assembly (400). The spring assembly (400) may be coupled to the first movable-plate assembly (102) and the second movable-plate assembly (104). The spring assembly (400) may be configured to bias the first movable-plate assembly (102) and the second movable-plate assembly (104) so as to maintain the first valve-stem assembly (202) and the second valve-stem assembly (204) in the valve-open position. The spring assembly (400) may be used for return motion of the first movable-plate assembly (102) and the second movable-plate assembly (104), for example, when no other predetermined forces act on the first movable-plate assembly (102) and the second movable-plate assembly (104).

Referring now to FIGS. 1A, 1B, the mold-tool system (100) may be further adapted so that the gear-drive assembly (152) may further include (by way of example and not limited to) a bladder assembly (402). FIG. 1A depicts the bladder assembly (402) in a deflated state. FIG. 1B depicts the bladder assembly (402) in an inflated state. The bladder assembly (402) may be positioned between the first movable-plate assembly (102) and the second movable-plate assembly (104). The bladder assembly (402) may be configured to (as depicted in FIG. 1B) inflate, abut, move and then maintain the first movable-plate assembly (102) and the second movable-plate assembly (104) in the valve-closed position. The bladder assembly (402) may be configured to deflate (as depicted in FIG. 1A) so as to permit movement of the first movable-plate assembly (102) and the second movable-plate assembly (104) back to the valve-open position.

It will be appreciated that the bladder assembly (402) may be used with another equivalent structure other that the spring assembly (400), so long as the first valve-stem assembly (202) and the second valve-stem assembly (204) are returned to the valve-open position upon deflation of the bladder assembly (402). For example the another equivalent structure may be configured to include an electrically-driven actuator that may be configured to push on each side (such as a nozzle side) of each of the first movable-plate assembly (102) and the second movable-plate assembly (104). For example, another bladder (not depicted) may be used to push the first movable-plate assembly (102) and the second movable-plate assembly (104) apart (to the valve-closed position), and then separate bladders may be used to push each plate to the valve-open position, etc.

For the case where the spring assembly (400) is used as depicted, the bladder assembly (402) may be configured to inflate, abut, move and then maintain the first movable-plate assembly (102) and the second movable-plate assembly (104) in the valve-closed position while overcoming the spring assembly (400). In addition, the bladder assembly (402) may be also configured to deflate so as to permit the spring assembly (400) to move the first movable-plate assembly (102) and the second movable-plate assembly (104) back to the valve-open position. For the case where the gear assembly (150) includes the bladder assembly (402), the gear assembly (150) may further include (and is not limited to) the bi-directional ball screw assembly (300) connecting the first movable-plate assembly (102) with the second movable-plate assembly (104). For the case where the gear assembly (150) includes the bladder assembly (402), the gear assembly (150) may further include (and is not limited to) a rack-and-pinion-gear assembly (not depicted but known) connecting the first movable-plate assembly (102) with the second movable-plate assembly (104).

Referring now to FIGS. 2A and 2B, the mold-tool system (100) may be adapted such that the gear-drive assembly (152) may include (and is not limited to): a motor assembly (500), and a pulley and belt assembly (503). The pulley and belt assembly (503) may be configured to couple the motor assembly (500) to the gear assembly (150). The motor assembly (500) may be configured to move the first movable-plate assembly (102) and the second movable-plate assembly (104) between the valve-open position and the valve-closed position.

Referring now to FIGS. 2A and 2B, for the case where the gear-drive assembly (152) includes the motor assembly (500) and the pulley and belt assembly (503), the gear assembly (150) may include (by way of example) the bi-directional ball screw assembly (300) connecting the first movable-plate assembly (102) with the second movable-plate assembly (104).

Referring now to FIGS. 2A and 2B, for the case where the gear-drive assembly (152) includes the motor assembly (500) and the pulley and belt assembly (503), the gear assembly (150) may include (by way of example) a rack-and-pinion-gear assembly (not depicted and known) connecting the first movable-plate assembly (102) with the second movable-plate assembly (104).

One purpose of the mold-tool system (100) may be to provide an actuation system that may enable stack hot runner systems with plate actuated valve pins to be produced with smaller shut-heights relative to what is available today. Single face hot runners with plate actuated valve pins are currently available with pneumatic, hydraulic or electric actuation means. Known systems with pneumatic or hydraulic actuation typically use a number of piston assemblies that push or pull the first movable-plate assembly (102) and the second movable-plate assembly (104). These known piston assemblies consume significant amounts of space in the hot runner assembly. Systems using an electric motor to actuate the first movable-plate assembly (102) and the second movable-plate assembly (104) typically have belt, gear or ball screw drives that move the first movable-plate assembly (102) and the second movable-plate assembly (104) using some form of cam mechanisms. These known systems may also suffer from similarly large hot runner shut-heights. Placing two independently actuated systems back to back for a stack mold may result in a prohibitively large hot runner shut-height. The mold-tool system (100) provides or permits a smaller hot runner shut-height by combining the motion and actuation systems for the first movable-plate assembly (102) and the second movable-plate assembly (104) into a singular system.

The plate-actuation system for a single faced hot runner typically consists of a drive system, which moves the first movable-plate assembly (102) and the second movable-plate assembly (104), an alignment bearing system that ensures consistent movement and physical stops that define the stroke of the first movable-plate assembly (102) and the second movable-plate assembly (104) (valve pin open and close). The integration of this actuation system into a hot runner requires a significant amount of plate thickness to be added, which in turn increases the overall mold shut-height. For known stack hot runner using individual pneumatic pistons to actuate each valve pin, the standard course of action would essentially be to place two single face hot runners back to back (maintaining independent actuation for all valve pins). If the same principle were to be applied to a stack system with plate-actuated valve pins, that is placing two independent plate-actuation systems back to back, the result may likely increase the hot runner shut-height (disadvantage) so much so that the overall mold shut-height may be too large to fit in an available injection molding machine.

Combining some or all of the components of two back to back plate-actuation systems into one, may provide an opportunity to reduce the hot runner shut-height. For example, two back to back plates may be actuated (in opposite directions) using the same drive system, and/or the alignment bearing system may be shared between the first movable-plate assembly (102) and the second movable-plate assembly (104), and/or both the first movable-plate assembly (102) and the second movable-plate assembly (104) may share a physical stop that limits the stroke of each of the first movable-plate assembly (102) and the second movable-plate assembly (104).

It will be appreciated that the assemblies and modules described above may be connected with each other as may be required to perform desired functions and tasks that are within the scope of persons of skill in the art to make such combinations and permutations without having to describe each and every one of them in explicit terms. There is no particular assembly, components, or software code that is superior to any of the equivalents available to the art. There is no particular mode of practicing the inventions and/or examples of the invention that is superior to others, so long as the functions may be performed. It is believed that all the crucial aspects of the invention have been provided in this document. In a back to back stack hot runner system with plate-actuated valve pins, the first movable-plate assembly (102) and the second movable-plate assembly (104) may move towards each other to open the valve pins and away from each other to close the valve pins. The proposed invention seeks to reduce hot runner shut-height by combining components or functions between the first movable-plate assembly (102) and the second movable-plate assembly (104).

In one example, the drive system that moves the first movable-plate assembly (102) and the second movable-plate assembly (104) further apart (to close the valve stems) may be shared. An inflatable bladder may be positioned between the first movable-plate assembly (102) and the second movable-plate assembly (104), such that when the bladder is inflated, the first movable-plate assembly (102) and the second movable-plate assembly (104) are pushed apart, thus moving the valve pins to the valve-closed position.

In another example, an alignment bearing system may be shared between the first movable-plate assembly (102) and the second movable-plate assembly (104). A bi-directional lead screw may be used to ensure that both the first movable-plate assembly (102) and the second movable-plate assembly (104) move the same distance (even in the opposite direction). A nut follower may be located on each lead screw direction, such that as the screw rotates in one direction, the nuts move further apart, and upon reversing the direction of rotation, the nuts move closer together. For each lead screw in the system, one nut may be mounted to each of the first movable-plate assembly (102) and the second movable-plate assembly (104), thus tying the movement of the first movable-plate assembly (102) and the second movable-plate assembly (104) together. In this example, the lead screw may be used for alignment and synchronous movement only (with a separate drive system), or the movement of the first movable-plate assembly (102) and the second movable-plate assembly (104) may be driven by the screw rotation.

In another example, a physical stop that defines the amount of stroke the first movable-plate assembly (102) and the second movable-plate assembly (104) may be capable of being actuated and may be shared. The shared physical stop may be mounted in the hot runner plates, or the first movable-plate assembly (102) and the second movable-plate assembly (104) may in fact stop on themselves, such that when the valve pins are in the valve-open position the first movable-plate assembly (102) and the second movable-plate assembly (104) are in contact and restrict each other's motion to further move the pin position.

It is understood that these examples described above are some examples of the mold-tool system (100). Someone skilled in the art of mechanical system design may be capable of devising a number of different arrangements in which some part of the actuation system is shared between the first movable-plate assembly (102) and the second movable-plate assembly (104) so as to actuate valve pins in different directions. Also, components from the different example listed above may be combined to make a more integrated plate actuation system.

It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (and is not limited to)” is equivalent to the word “comprising”. It is noted that the foregoing has outlined the non-limiting embodiments (examples). The description is made for particular non-limiting embodiments (examples). It is understood that the non-limiting embodiments are merely illustrative as examples.

What is claimed is:

1. A mold-tool system (100), comprising:
a first movable-plate assembly (102) being configured to attach with a first valve-stem assembly (202) of a first runner assembly (200);
a second movable-plate assembly (104) being configured to attach with a second valve-stem assembly (204) of a second runner assembly (201); and
a plate-actuator assembly (106) being coupled with the first movable-plate assembly (102) and with the second movable-plate assembly (104), the plate-actuator assembly (106) being configured to move the first movable-plate assembly (102) and the second movable-plate assembly (104) in opposite directions between a valve-open position and a valve-closed position.

2. The mold-tool system (100) of claim 1, wherein:
the plate-actuator assembly (106) includes:
a gear assembly (150) being coupled to the first movable-plate assembly (102) and the second movable-plate assembly (104), the gear assembly (150) being configured to:
(i) align the first movable-plate assembly (102) with the second movable-plate assembly (104) so that a side-to-side movement is maintained between the first movable-plate assembly (102) and the second movable-plate assembly (104); and
(ii) permit simultaneous movement of the first movable-plate assembly (102) with the second movable-plate assembly (104) at a matched speed.

3. The mold-tool system (100) of claim 2, wherein:
the plate-actuator assembly (106) further includes:
a gear-drive assembly (152) being operatively connected with the gear assembly (150), the gear-drive assembly (152) being configured to move the gear assembly (150) so that the first movable-plate assembly (102) and the second movable-plate assembly (104) are movable between the valve-open position and the valve-closed position.

4. The mold-tool system (100) of claim 3, wherein:
the gear assembly (150) includes:
a bi-directional ball screw assembly (300) connecting the first movable-plate assembly (102) with the second movable-plate assembly (104).

5. The mold-tool system (100) of claim 3, wherein:
the gear assembly (150) includes:
a rack-and-pinion-gear assembly connecting the first movable-plate assembly (102) with the second movable-plate assembly (104).

6. The mold-tool system (100) of claim 3, wherein:
the gear-drive assembly (152) includes:
a spring assembly (400) being coupled to the first movable-plate assembly (102) and the second movable-plate assembly (104), the spring assembly (400) being configured to bias the first movable-plate assembly (102) and the second movable-plate assembly (104) so as to maintain the first valve-stem assembly (202) and the second valve-stem assembly (204) in the valve-open position.

7. The mold-tool system (100) of claim 3, wherein:
the gear-drive assembly (152) further includes:
a bladder assembly (402) being positioned between the first movable-plate assembly (102) and the second movable-plate assembly (104), the bladder assembly (402) being configured to:
(i) inflate, abut, move and then maintain the first movable-plate assembly (102) and the second movable-plate assembly (104) in the valve-closed position, and
(ii) deflate so as to permit movement of the first movable-plate assembly (102) and the second movable-plate assembly (104) back to the valve-open position.

8. The mold-tool system (100) of claim 6, wherein:
the gear-drive assembly (152) further includes:
a bladder assembly (402) being positioned between the first movable-plate assembly (102) and the second movable-plate assembly (104), the bladder assembly (402) being configured to:
(i) inflate, abut, move and then maintain the first movable-plate assembly (102) and the second movable-plate assembly (104) in the valve-closed position while overcoming the spring assembly (400), and
(ii) deflate so as to permit the spring assembly (400) to move the first movable-plate assembly (102) and the second movable-plate assembly (104) back to the valve-open position.

9. The mold-tool system (100) of claim 8, wherein:
the gear assembly (150) includes:
a bi-directional ball screw assembly (300) connecting the first movable-plate assembly (102) with the second movable-plate assembly (104).

10. The mold-tool system (100) of claim 8, wherein:
the gear assembly (150) includes:
a rack-and-pinion-gear assembly connecting the first movable-plate assembly (102) with the second movable-plate assembly (104).

11. The mold-tool system (100) of claim 3, wherein
the gear-drive assembly (152) includes:
a motor assembly (500);
a pulley and belt assembly (503) being configured to couple the motor assembly (500) to the gear assembly (150), the motor assembly (500) being configured to move the first movable-plate assembly (102) and the second movable-plate assembly (104) between the valve-open position and the valve-closed position.

12. The mold-tool system (100) of claim 11, wherein;
the gear assembly (150) includes:
a bi-directional ball screw assembly (300) connecting the first movable-plate assembly (102) with the second movable-plate assembly (104).

13. The mold-tool system (100) of claim 11, wherein:
the gear assembly (150) includes:
a rack-and-pinion-gear assembly connecting the first movable-plate assembly (102) with the second movable-plate assembly (104).

14. A molding system having the mold-tool system (100) of any one of claims 1 to 13.
